(19) United States
(12) Patent Application Publication
(10) Pub. No.: US 2025/0127326 A1
(43) Pub. Date: Apr. 24, 2025

(54) DEVICE FOR HANDLING A DRINKABLE LIQUID

(71) Applicant: PI-Design AG, Baar (CH)

(72) Inventor: Jorgen BODUM, Meggen (CH)

(73) Assignee: PI-Design AG, Baar (CH)

(21) Appl. No.: 18/690,285

(22) PCT Filed: Aug. 24, 2022
(86) PCT No.: PCT/EP2022/073563

§ 371 Date: Mar. 8, 2024

(30) Foreign Application Priority Data
Sep. 8, 2021 (DE) 10 2021 123 268.6

(51) Int. Cl. A47J 31/44; A47G 19/14; A47J 31/20

(52) U.S. Cl. CPC A47J 31/4425; A47G 19/14; A47J 31/20

(57) ABSTRACT

The present invention relates to a device (10) for handling a drinkable liquid, in particular tea and coffee, comprising: a container (12), which has an outer surface (14) and an inner surface (16), wherein the inner surface (16) surrounds a receiving chamber (26) into which a drinkable liquid can be introduced and from which the drinkable liquid can be removed; a support unit (28) having a wall structure (30), wherein the wall structure (30) surrounds a support space (32) into which the container (12) can be at least partially introduced; and a connecting element (42), which can be fastened to the support unit (28) and can be brought into contact with the outer surface (14) such that the container (12) is fixed in the support space (32) when the container (12) is introduced into the support space (32) and the connecting element (42) is fastened to the support unit (28).

The present invention relates to a device for handing a drinkable liquid, in particular tea and coffee.

Such devices are, for example, coffee pots or teapots that typically comprise porcelain or plastic. The fully prepared coffee or the fully prepared tea is poured into the coffee pot or into the teapot and the latter are subsequently transported to where the coffee and tea are to be consumed. The coffee pot or the teapot is placed on a table in the majority of cases. The coffee or tea can subsequently be poured into a cup by a corresponding tilting of the coffee pot or teapot.

Coffee pots and teapots are, however, also known with which the coffee or tea is prepared in the coffee pot or teapot. Such coffee pots and teapots can, for example, have a container having an opening and a base, wherein the container typically has a cylindrical or prismatic shape. To prepare the coffee or tea, the desired amount of insoluble material such as coffee powder or tealeaves is poured into the container and hot water is then poured over it. The coffee powder or tealeaves is/are subsequently left to brew for a certain time. A piston filter arrangement that comprises a piston rod and a filter press fastened to the piston rod is then introduced into the container. The piston rod is typically displaceably supported in a lid that can be placed over the opening and by which the container can be closed. The filter press has a shape corresponding to the cross-section of the container so that the filter press terminates laterally with the container. The filter press is pressed toward the base by means of the piston rod. As a consequence of this, the extracted coffee powder or the extracted tealeaves is/are separated from the coffee or tea and is/are compressed in the region of the closed end. The coffee or tea filtered in this manner can now be drunk. Once the coffee or tea has been completely consumed, the piston filter arrangement is pulled out of the container and the compressed coffee powder or the compressed tealeaves are removed from the container. Such coffee pots and teapots are described, for example, in DE 34 32 289 C1, WO 02/067739 A1, EP 2 798 985 A1 and WO 96/035360 A1.

It can occur, not only, but in particular with such coffee pots and teapots that they may topple over when placing the piston filter arrangement on the container. In a number of cases, the coffee pots and teapots are therefore introduced into a support unit that in particular serves to stabilize the introduced coffee pot or teapot and to prevent a toppling over. As mentioned, hot water is poured over the coffee powder or the tealeaves to prepare the coffee or tea so that the container heats up so much that it can practically not be safely gripped by the naked fingers. To simplify the gripping, a large number of support units also have one or more handle sections that are arranged so far away from the container that the heat is not conducted into the handle sections, or only to a much reduced degree.

The support units here have a wall structure that surrounds a support space. The container is introduced into this support space. It is therefore usual to dimension the wall structure such that it has a small undersize with respect to the container. As a result of this, a certain friction acts between the container and the wall structure, whereby the container is held in the support space by frictional engagement.

DE 10 2014 224 270 A1 shows a double-walled drinking vessel, wherein the outer container is connected to the inner container by frictional engagement by means of a connection piece.

In many cases, the container is made of glass or plastic. The situation arises with containers made from glass, however, that the production tolerances are comparatively high. It is to this extent not always the case that the wall structure actually has an undersize or the at least required undersize with respect to the container. In this case, the frictional engagement between the container and the wall structure is either not present at all or is too small. As a result of this, the container cannot be securely held in the support space. The same can occur due to a relaxation of in particular the materials used for the wall structure. It may in particular occur when the fully prepared coffee or the fully prepared tea is to be poured from the container into a cup that the container suddenly releases from the support unit in an uncontrolled manner, which may result in a spilling of the coffee or tea or even in a breaking of the container.

It is therefore an object of an embodiment of the present invention to provide a device with which a remedy for the above-described situation can be provided. It should in particular be made possible to securely fix the container in the support space independently of production tolerances by simple and inexpensive means.

This object is achieved by the features specified in claim 1. Advantageous embodiments are the subject of the dependent claims.

An embodiment of the present invention relates to a device for handing a drinkable liquid, in particular tea and coffee, comprising
a container that has
   an outer surface and
   an inner surface, wherein the inner surface surrounds a reception space into which a drinkable liquid can be introduced and from which the drinkable liquid can be discharged,
a support unit having a wall structure, wherein the wall structure surrounds a support space into which the container can be at least partially introduced, and
a connection element that is fastenable to the support unit and can be brought into contact with the outer surface such that the container is fixed in the support space when the container has been introduced into the support space and the connection element has been fastened to the support unit.

A wall structure can be understood in the following as a wall that is continuous or interrupted and that can comprise one or more elements, in particular sheet metal elements. The connection element represents an additional component, in particular with respect to the devices known from the prior art for handing a drinkable liquid, and is in particular not formed by the wall structure itself, but is rather fastened thereto.

The container can be fixed in the support space using the connection element, and indeed independently of the undersize of the wall structure actually pertaining with respect to the container and independently of relaxation processes of the wall structure. It is hereby prevented that the container is released in an uncontrolled manner from the support unit, in particular when pouring coffee or tea. Since the connection element comes into contact with the outer surface of the container, it is not necessary to take certain precautions to prevent the uncontrolled release. It is in particular not necessary to provide a connection having material continuity or a shape match, with such connections not being precluded. Provision can be made that the connection element is connected to the outer surface of the container and can also be released from it again with a comparatively small force. Since the support unit does not come into contact with the drinkable liquid in the use of the device in accordance with its intended purpose, there is generally no need to clean the support unit, in a dishwasher, for example. However, the situation is different for the container. In the event that the connection element can be released from the outer surface of the container again with a comparatively small force, the container can be separated from the support unit and subsequently connected to it again without any great force.

In accordance with a further embodiment, the connection element can be releasably fastenable to the wall structure. It is possible in this embodiment to retrofit already existing support units with the connection element, with the connection element being able to be subsequently mounted on the wall structure. In addition, a connection element can be replaced if it is no longer functional for whatever reason.

In accordance with a further developed embodiment, the connection element can be releasably fastenable to the wall structure by means of a screw connection. A screw connection can be provided and operated in a comparatively simple manner. A screw connection is moreover characterized by high reliability.

In a further developed embodiment, the connection element can remain in contact with the outer surface when the connection element has been released from the wall structure. Depending on the design of the connection element, it may be desired that it is also cleaned. In this case, the connection element is separated from the support unit, but not from the container. The container can be cleaned together with the connection element in a dishwasher, for example.

In a further embodiment, the connection element can be formed as a suction cup or can at least comprise a suction cup. A suction cup can be provided in a comparatively inexpensive manner. Only a relative movement between the suction cup and the container has to be carried out for the connection to the outer surface of the container. No further steps are required for the connection so that the container can be connected to the suction cup in a very simple manner. Depending on the size of the suction cup, it can also be released from the container again with a comparatively small force.

A further developed embodiment can be characterized in that the suction cup is produced from a plastic that can be injection molded and the screw connection comprises a threaded bolt about which the suction cup is injection molded. The suction cup can be used in conjunction with a screw connection in this manner without additional fastening measures being required to fasten the threaded bolt to the suction cup. The threaded bolt can here be part of a screw, with the suction cup being injection molded about the screw head to achieve a secure anchoring of the threaded bolt in the suction cup.

In accordance with a further embodiment, an anchorage element about which the suction cup is injection molded can be screwed onto the threaded bolt. Other types of fastening of the anchorage element such as welding or the like are likewise conceivable. The threaded bolt can also be made in one piece. In this embodiment, the threaded bolt is used, on the one hand, to provide the screw connection for the fastening of the suction cup to the support unit, but, on the other hand, also to provide a connection to the anchorage element. The anchorage element has an external thread complementary to the thread of the threaded bolt for this purpose. The anchorage element ensures that the threaded bolt can be connected to the suction cup with sufficient strength.

It may be suitable in a further embodiment that
the container has a base and
the wall structure forms a support region, wherein
the support region of the device can be placed on a mat,
the container is moved toward the support region on its introduction into the support space, and
the suction cup is connectable or connected to the wall structure in the support region.

As mentioned in the introduction, the container is introduced into the support space to be stabilized by the support unit. A relative movement, that in this embodiment is also simultaneously used to press the base of the container toward the suction cup to establish the connection between the container and the suction cup, is consequently carried out between the support unit and the container. To this extent, no additional steps are required in comparison with devices known from the prior art to establish the connection between the suction cup and the container. A very comfortable handling of the device is consequently made possible in this embodiment.

In a further developed embodiment, the wall structure can have a recess in the support region and the suction cup can be connectable or connected to the wall structure in the recess. Due to the fact that the suction cup is arranged in the recess, the former only projects into the reception space by a small amount. The container can hereby be pushed very far into the reception space, whereby the stability of the device is increased since the center of gravity of the container can be arranged very low.

In a further developed embodiment, the wall structure can have radially protruding projections in the support region. The stability of the device is likewise increased due to the radially protruding projections since the moment of tilt that is required for the toppling over of the device is increased.

In a further developed embodiment, the container can be produced from glass. A number of reasons speak for the use of glass as the material for the container. The high inertia of glass must inter alia be pointed out at this point, whereby it can be ensured that no amounts or no significant amounts of foreign matter can move from the container into the drinkable liquid. The transparency of glass moreover speaks for the use as the material for the container since the extraction process can be observed during the preparation of coffee or tea. In addition, a very planar surface can be provided by glass that makes it possible that the suction cup can contact the outer surface of the container over the full circumference and can thus provide its functions.

In a further embodiment, at least one handle section by which the support unit can be gripped is arranged at the wall structure. As initially mentioned, hot water is poured over the coffee powder or over the tealeaves for the preparation of coffee or tea. The container is consequently heated so that it can no longer be gripped by the naked hands. In a number of cases, sheet metal is used for the support unit, with this being able to be understood within the framework of this description as a flat metal body. In most cases, the support unit therefore does not provide any large distance from the container. Metal furthermore has a comparatively high thermal conductivity. The support unit can consequently also not simply be gripped in the event that there is a hot liquid in the container. The provision of at least one handle section, however, makes the gripping of the device possible even when there is a hot liquid in the container. The handle section can, for example, be produced from a plastic that has a low thermal conductivity.

A further developed embodiment can be characterized in that
the container has an annular section that separates the inner surface from the outer surface and that surrounds an opening, and
the device has a piston filter arrangement that can be introduced into the reception space through the opening.

The use of a piston filter arrangement makes it possible to separate the coffee powder or the tealeaves from the remaining liquid after the liquid was able to interact with the coffee powder or with the tealeaves for a sufficiently long time to extract the respective flavoring agents. The drinking pleasure can hereby be increased since the coffee drinker or tea drinker does not also have to drink the solid coffee powder or solid tealeaves.

In accordance with a further developed embodiment, the wall structure can have a plurality of perforations. In this embodiment, the wall structure is not continuous, but is rather interrupted by the perforations. No material is present in the perforations. The wall structure can be frame-shaped or lattice-shaped. To this extent, the wall structure can be produced with a small material effort, whereby the weight of the wall structure is also kept low in addition to the material saving.

Exemplary embodiments of the invention will be explained in more detail in the following with reference to the enclosed drawings. There are shown

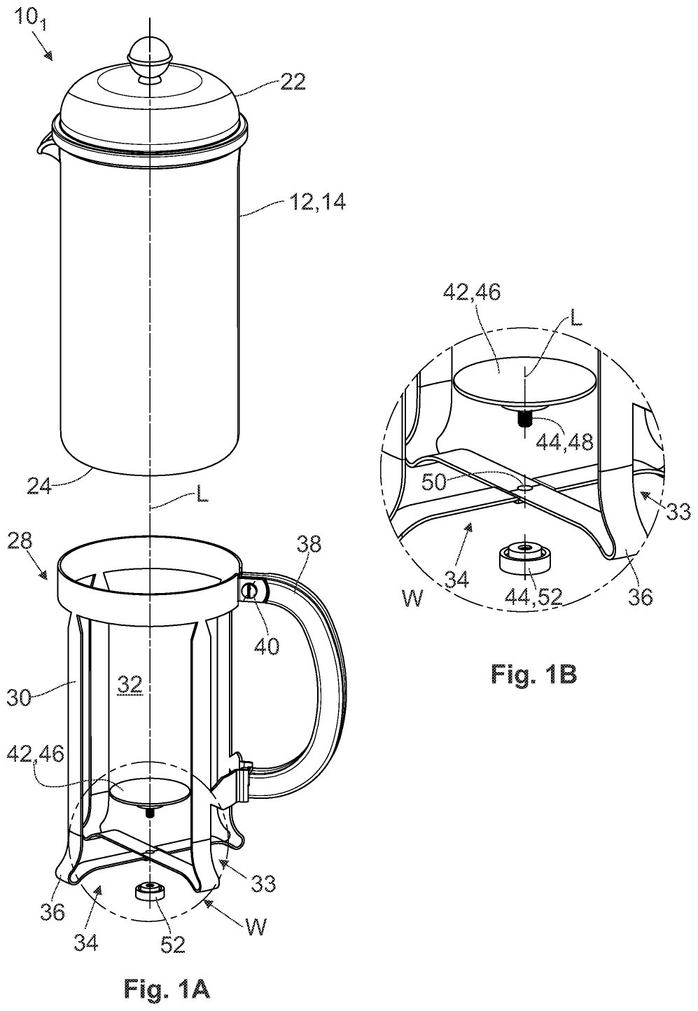

FIG. 1A a perspective exploded representation of a first embodiment of the proposed device for handling a drinkable liquid;

FIG. 1B an enlarged representation of the section marked W in FIG. 1A;

FIG. 1C a sectional representation through the device shown in FIG. 1A in the assembled state;

FIG. 1D an enlarged representation of the section marked X in FIG. 1C;

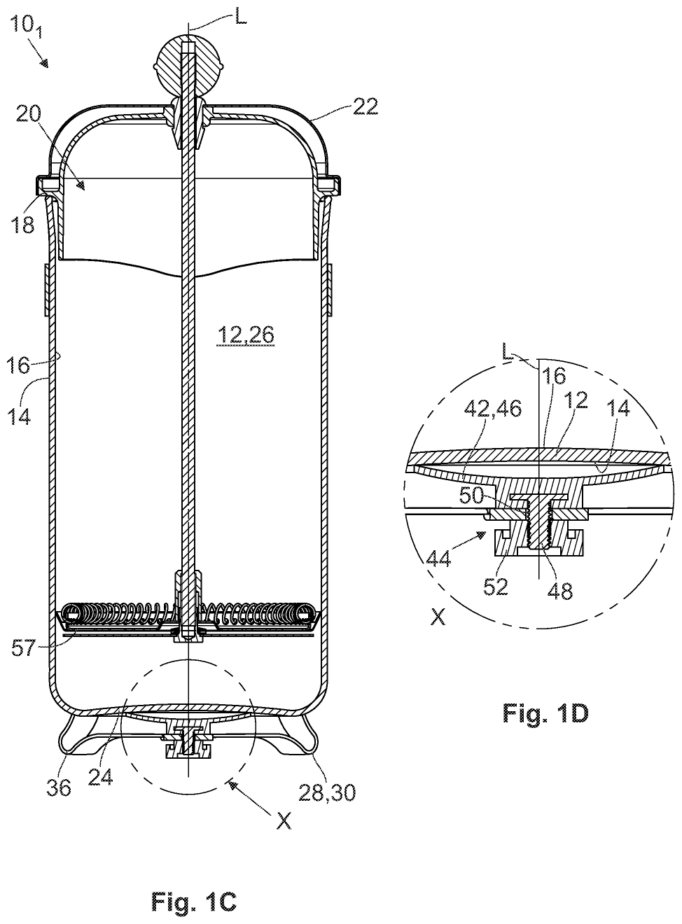

FIG. 2A a sectional representation through a second embodiment of the proposed device;

FIG. 2B an enlarged representation of the section marked Y in FIG. 2A;

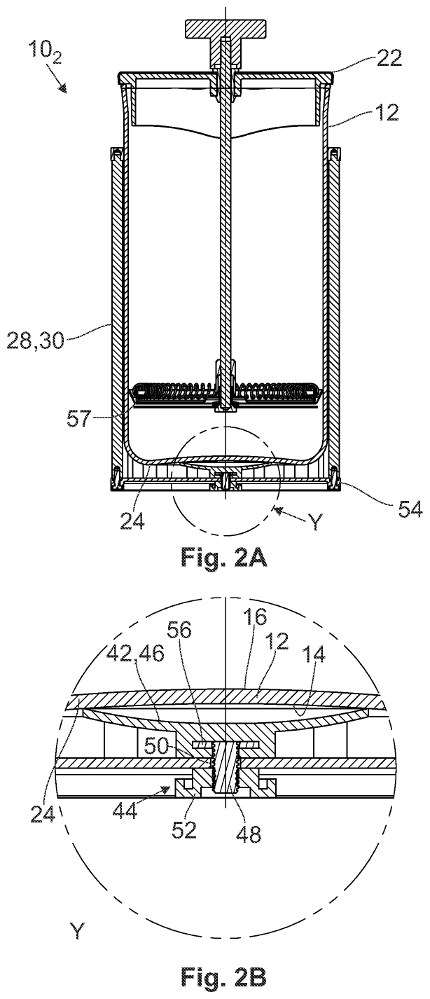

FIG. 3 a perspective exploded representation of a third embodiment of the proposed device;

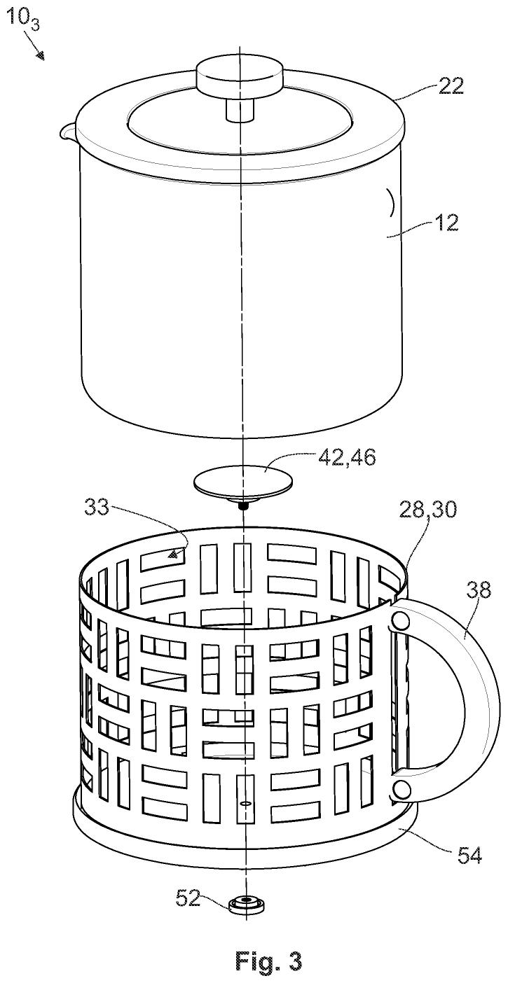

FIG. 4A a perspective exploded representation of a fourth embodiment of the proposed device for handling a drinkable liquid;

FIG. 4B an enlarged representation of the section marked Z in FIG. 4A; and

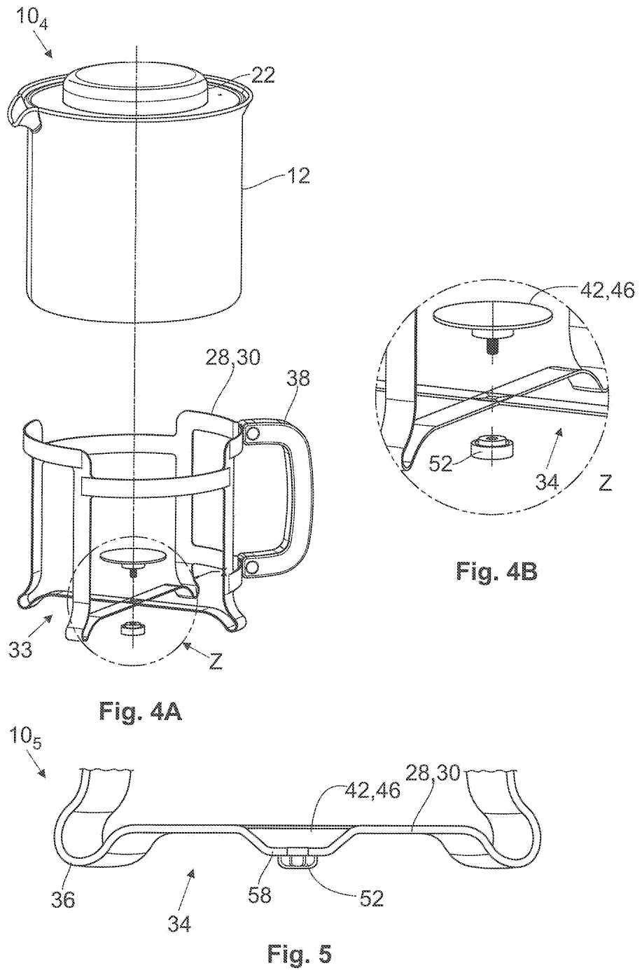

FIG. 5 a basic representation of a support region of a wall structure of a fifth embodiment of the proposed device.

A first embodiment of the proposed device 10₁ is shown perspectively with reference to an exploded representation in FIG. 1A. Further representations of the proposed device 10₁ in accordance with the first embodiment are additionally shown in FIGS. 1B to 1D so that the following statements equally refer to FIGS. 1A to 1D if not otherwise stated.

The device 10₁ comprises a container 12 that has a cylindrical shape in the embodiment shown. The container 12 can, for example, be produced from glass or from plastic and can have an outer surface 14 and an inner surface 16, with the inner surface 16 in particular being able to be recognized in FIG. 1C. An annular section 18 that surrounds an opening 20 and separates the outer surface 14 from the inner surface 16 can be recognized from FIG. 1C. A piston filter arrangement 22 whose functioning will be looked at in more detail below is inserted into the opening 20. The container 12 additionally has a closed base 24. The inner surface 16 bounds a reception space 26 (see FIG. 1C) in which a drinkable liquid can be introduced.

The device 10₁ further comprises a support unit 28 that has a wall structure 30. In the present embodiment, the wall structure 30 is formed by metal sheets, with the wall structure 30 surrounding a support space 32 in which the container 12 can be introduced, as is shown in FIG. 1C. The wall structure 30 therefore has a number of perforations 33 through which a direct access to the container 12 is possible. The wall structure 30 is of a frame-like design in the device 10₁ in accordance with the first embodiment. The wall structure 30 additionally defines a longitudinal axis L. The wall structure 30 forms a support region 34 by which the support unit 28 and the total device 10₁ can be placed on a mat. In the embodiment shown, projections 36 are arranged in the support region 34 that project radially outwardly over the remaining wall structure 30 with respect to the longitudinal axis L.

A handle section 38 is furthermore provided that is fastened to the wall structure 30, for example using screws 40.

As can in particular be seen from FIG. 1B, the device 10₁ comprises a connection element 42 that is releasably connectable or connected to the support unit 28 by means of a screw connection 44. In the embodiment shown, the connection element 42 is designed as a suction cup 46 and is fastened to the wall structure 30 by the screw connection 44 in the support region 34 (see in particular FIG. 1D). It can likewise be recognized from FIG. 1D that the screw connection 44 has a threaded bolt 48 that is part of a screw and that has a T-shaped design. The threaded bolt 48 is surrounded by the suction cup 46 at the screw head, while the remaining region of the threaded bolt 48 projects from the suction cup 46. Provision can be made to produce the suction cup 46 from a plastic capable of injection molding so that the suction cup 46 can be injection molded around the threaded bolt 48. In this case, no further measures are necessary to connect the threaded bolt 48 to the suction cup 46.

The suction cup 46 can be guided through a passage hole 50 of the wall structure 30 by the section projecting from the suction cup 46 and can be secured at the wall structure 30 by a nut 52, for example a knurled nut. The suction cup 46 thus fastened to the support unit 28 is shown in FIGS. 1C and 1D.

The device 10₁ can be operated in the following manner: The suction cup 46 is first fastened to the wall structure 30 in the described manner. The container 12 is subsequently aligned approximately coaxially to the longitudinal axis L of the support unit 28, as is shown in FIG. 1A. The container 12 is introduced into the support space 32 by a movement directed along the longitudinal axis L until the base 24 of the container 12 comes into contact with the suction cup 46. The suction cup 46 has to be compressed a little by a correspondingly large force so that the suction cup 46 can fix the container 12 in the support unit 28. As soon as this has been done, the piston filter arrangement 22 can be removed from the container 12, if it has not already been done, and an insoluble material, in this case coffee powder, is introduced into the container 12. Hot water is subsequently poured over the coffee powder and a certain time elapses until a sufficient concentration of flavoring agents has been extracted from the coffee powder. The piston filter arrangement 22 is now introduced into the container 12 through the opening 20 and a filter press 57 of the piston filter arrangement is displaced toward the base 24 of the container 12 to separate the insoluble material from the liquid. The filter press 57 is in an end position in FIG. 1C. The coffee powder is located below the filter press 57 so that the liquid thereunder does not have any coffee powder or only a very small amount of coffee powder. The device 10₁ can now be gripped at the handle section 38 to pour the now completely prepared coffee into a coffee cup.

Once the coffee has been completely removed, the piston filter arrangement 22 is removed from the container 12 and the coffee powder is poured into a bin, for example. To clean the container 12, it is separated from the support unit 28. This can be done in various manners: The suction cap 46 can be designed such that only a comparatively small force is required to separate the container 12 from the support unit 28. In this case, the container 12 can be cleaned, in a dishwasher for example, without the suction cup 46. Alternatively the nut 52 can be released from the threaded bolt 48 and the container 12 can only then be removed from the support space 32. In this case, the suction cup 24 remains at the container 12. The container 12 is then cleaned together with the suction cup 46.

A second embodiment of the proposed device 10₂ is shown with reference to sectional representations in FIGS. 2A and 2B. The second embodiment also serves the preparation of coffee, with the procedure in this respect being the same that has been described with reference to the first embodiment. The main differences of the second embodiment in comparison with the first embodiment of the device 10₁ are largely limited to the design of the support unit 28, with it having to be emphasized that the support unit 28 does not have any radial projections 36, but is rather provided with a support ring 54 in the support region 34. The screw connection 44 is additionally designed somewhat differently. The threaded bolt 48 is not part of a screw in this case. A threaded bolt 48 per se is rather used onto which an anchorage element 56 has been screwed that is surrounded by the suction cup 46 (see in particular FIG. 2B). The suction cup 46 is also injection molded about the threaded bolt 48 and the anchorage element 56 in this case.

In FIG. 3 a third embodiment and in FIGS. 4A and 4B a fourth embodiment of the proposed device 10₃, 10₄ are shown. The third embodiment and the fourth embodiment of the proposed device 10₃, 10₄ are devices serving the preparation of tea. In this respect, the general procedure is the same as that that has been described for the preparation of coffee. The main differences are that the containers 12 for the devices 10₁, 10₂ for the preparation of coffee are narrower and higher in comparison with the devices 10₃, 10₄ for the preparation of tea. The perforations 33 of the wall structure 30 in the third embodiment of the device 10₃ are arranged such that the wall structure 30 is of a lattice shape.

The perforations 33 in the fourth embodiment of the device 10₄ are designed such that the wall structure 30 is of a frame shape.

In FIG. 5, the support region 34 of a wall structure 30 of a fifth embodiment of the proposed device 10₅, not further shown, is shown that comprises the already mentioned radial projections 36. The wall structure 30 forms a recess 58 in which the suction cup 46 is arranged. As a consequence, in comparison with the previously shown four embodiments 10₁ to 10₄, the container 12 is introduced so far into the support space 32 until the container 12 almost comes into contact with the support region 34.

### REFERENCE NUMERAL LIST

10 device
10₁-10₅ device
12 container
14 outer surface
16 inner surface
18 annular section
20 opening
22 piston cylinder arrangement
24 base
26 reception space
28 support unit
30 wall structure
32 support space
33 perforations
34 support region
36 projections
38 handle section
40 screws
42 connection element
44 screw connection
46 suction cup
48 threaded cup
50 passage hole
52 nut
54 support ring
56 anchorage element
57 press filter
58 recess
L longitudinal axis

1. A device for handling a drinkable liquid, in particular tea and coffee, comprising
a container that has
an outer surface and
an inner surface, wherein the inner surface surrounds a reception space into which a drinkable liquid can be introduced and from which the drinkable liquid can be discharged,
a support unit having a wall structure, wherein the wall structure surrounds a support space into which the container can be at least partially introduced, and
a connection element that is fastenable to the support unit and can be brought into contact with the outer surface such that the container is fixed in the support space when the container has been introduced into the support space and the connection element has been fastened to the support unit.

2. A device in accordance with claim 1,
wherein the connection element is releasably fastenable to the wall structure.

3. A device in accordance with claim 2,
wherein the connection element is releasably fastenable to the wall structure by means of a screw connection.

4. A device in accordance with claim 2,
wherein the connection element remains in contact with the outer surface when the connection element has been released from the wall structure.

5. A device in accordance with claim 1,
wherein the connection element is formed as a suction cup or at least comprises a suction cup.

6. A device in accordance with claim 3,
wherein the suction cup is produced from a plastic that can be injection molded and the screw connection comprises a threaded bolt about which the suction cup has been injection molded.

7. A device in accordance with claim 6,
wherein an anchorage element about which the suction cup has been injection molded has been screwed onto the threaded bolt.

8. A device in accordance with claim 5, wherein
the container has a base and
the wall structure forms a support region, wherein
the support region of the device can be placed on a mat,
the container is moved toward the support region on its introduction into the support space, and
the suction cup is connectable or connected to the wall structure in the support region.

9. A device in accordance with claim 8,
wherein the wall structure has a recess in the support region and the suction cup is connectable or connected to the wall structure in the recess.

10. A device in accordance with claim 8,
wherein the wall structure has radially protruding projections in the support region.

11. A device in accordance with claim 1,
wherein the container is produced from glass.

12. A device in accordance with claim 1,
wherein at least one handle section by which the support unit can be gripped is arranged at the wall structure.

13. A device in accordance with claim 1,
wherein
the container forms an annular section that separates the inner surface from the outer surface and that surrounds an opening, and
the device has a piston filter arrangement that can be introduced into the reception space through the opening.

14. A device in accordance with claim 1,
wherein the wall structure has a number of perforations.
